(19) United States
(12) Patent Application Publication
(10) Pub. No.: US 2016/0141053 A1
(43) Pub. Date: May 19, 2016

(54) SUPERSONIC MOLECULAR BEAM INJECTING DEVICE

(71) Applicants: Lianghua YAO, Sichuan (CN); Beibin FENG, Sichuan (CN); Chengyuan CHEN, Sichuan (CN); SOUTHWESTERN INSTITUTE OF PHYSICS, Sichuan (CN)

(72) Inventors: Lianghua YAO, Chengdu (CN); Beibin FENG, Chengdu (CN); Chengyuan CHEN, Chengdu (CN)

(21) Appl. No.: 14/786,657

(22) PCT Filed: Dec. 30, 2013
(86) PCT No.: PCT/CN2013/090985

§ 371 Date: Oct. 23, 2015

(30) Foreign Application Priority Data
Jul. 18, 2013 (CN) 201310301066.X

(51) Int. Cl. G21B 1/15

(52) U.S. Cl. CPC G21B 1/15

(57) ABSTRACT

This device includes a molecular beam valve, a cold/hot precipitator and a magnetic shielding cylinder, wherein molecular beam valve is nested in cold/hot precipitator and precipitator is nested in magnetic shielding cylinder and molecular beam valve is fixed on flange connected to vacuum chamber of a fusion device, outlet of molecular beam valve has a lengthened Laval nozzle. The device solves technical problem that plasma feeding efficiency of existing supersonic gas injector is below 20% during operation of a high-performance Tokamak high confinement mode and constraint is poor; and an effect of applying device to existing large-scale superconducting Tokamak has shown: feeding efficiency reaches 40%; and a function of triggering a low constraint mode converted to a high constraint mode; and a function of mitigating instability of an edge localized mode, so heating load on wall surfaces of fusion device is reduced by 50%, thereby maintaining normal H-mode operation.

### FIELD OF THE INVENTION

The invention belongs to the nuclear fusion technology, and particularly relates to a supersonic molecular beam injecting device.

### BACKGROUND OF THE INVENTION

The supersonic molecular beam injection is a new nuclear fusion fueling method based on conventional jet technique.

The patent ‘Supersonic Gas or Cluster Jet Injection’ (ZL10105647.1), discloses an apparatus of supersonic gas injection which has the advantage of making the fueling efficiency doubled; taking fueling gas deuterium for example, the fueling efficiency is 30˜60% with supersonic gas injection versus 15˜30% with conventional jet fueling method. Particles of supersonic gas fueling may enter the plasma confinement region. Therefore, it benefits the increase of the plasma density and the density peaking and improves the energy confinement. These results are achieved in a small-scale (R=1.02 m, a=0.20 m) HL-1M Tokamak device. However, with the development of the nuclear fusion technology, the size of reactor enlarged, the method of heating and confinement developed and the pressure of plasma (temperature multiplied by density) increased, the present Tokamak standard running program is high confinement mode (H-mode); it is expected that the ITER (International Thermonuclear Experimental Reactor) will be operated on this mode, which has high pressure edge transport barriers (ETB) to improve the plasma confinement performance, but with the difficulty of fueling as well.

The size of modern large-scale Tokamak is large, and the distance between fueling inlet and the plasma edge is over 3 meters which is over 10 times compared with the HL-1M device in the patent ‘Supersonic Gas or Cluster Jet Injection’(ZL10105647.1) with the edge plasma pressure multiplying; therefore, the requirement of fueling becomes more strict.

When the Tokamak device is operated in high confinement mode, the supersonic gas injection has the following defects:

(1) When the Tokamak H-mode plasma is operated, the efficiency of the conventional jet fueling decreases to below 10%. The efficiency of the supersonic gas injection fueling decreases to below 20%, and the direct penetration of particles through high pressure transport barriers becomes harder, with the increase of density relying on particles diffusion.

(2) The Laval nozzle throat depth of the supersonic gas injecting device is about 1 mm, and the advantage of supersonic beam current directionality is not fully used; with the great increase of molecular beam injection distance, the effect of divergent peripheral part in the particle current becomes apparent and the plasma pressure of injected object is multiplied; therefore, the gap with the conventional jet fueling is narrowed gradually.

(3) With the size of the nuclear fusion device getting larger, the edge plasma temperature and density is increasing, and the amount of particles emitted by the supersonic gas injecting device penetrating the last closed magnetic flux surface (LCFS) into plasma region becomes less. Therefore, even operated in the time of low confinement mode (L-mode), the energy confinement performance improved by the density peak is not obvious.

### SUMMARY OF THE INVENTION

The technical problem needs to be solved by this invention is: the prior art of supersonic gas injecting device of the high-performance Tokamak operated in high confinement mode has the defects of low efficiency of plasma fueling less than 20% and bad confinement performance.

The present invention is summarized as follows:

In the present invention there is provided a supersonic molecular beam injecting device comprising a molecular beam valve, a cold/heat precipitator and a magnetic shielding cylinder, said molecular beam valve located in said cold/heat precipitator and said cold/heat precipitator located in said magnetic shielding cylinder, said molecular beam valve fixed on a flange which is connected to the vacuum chamber of a fusion device, the outlet of said molecular beam valve having a lengthened Laval nozzle.

As preferred choices:

The inlet of said molecular beam valve is connected to high pressure gas by the high pressure seal joint; the outlet of said molecular beam valve has a lengthened Laval nozzle, and the size of the aperture of said molecular beam valve is the same as the size of the aperture of said lengthened Laval nozzle with the apertures on the same axis.

The size of the aperture of said molecular beam valve has specifications of 0.1 mm to 0.5 mm and the length of said lengthened Laval nozzle is over 58 mm with a conical inner wall of which the half-angle of the cone has specifications of 6° to 25°.

Said cold/heat precipitator is connected to a cold/heat provider system by a cold/heat channel joint, said cold provider system a liquid nitrogen infusion system, and said heat provider system a pressure steam infusion system, with a temperature tuning range 100˜500K. The velocity of the supersonic molecular beam is increased by raising the temperature of the gas to increase the depth of the injection and the fueling efficiency.

There is an adiabatic sleeve located between said cold/heat precipitator and said magnetic shielding cylinder, and said cold/heat precipitator has temperature measuring device.

Said magnetic shielding cylinder is made of conventional soft iron material, and is connected by a molecular beam injection line positioning cylinder to a flange which is connected to the vacuum chamber of a fusion device.

The advantages of the invention are as follows:

The improved supersonic molecular beam injecting device of the high-performance Tokamak operated in high confinement mode (H-mode), can make the molecular beam penetrate the last closed magnetic flux surface into the plasma pedestal region; while maintaining high efficiency of fueling (40%), it has made achievements on the present large-scale superconducting Tokamak (EAST by Chinese Academy of Sciences and KSTAR by National Fusion Research Institute, Korea): (a) reducing the power threshold in the transition from low confinement mode to high confinement mode (L-H); (b) mitigating the edge localized mode (ELM) instability and reducing the heat load on the wall surfaces of the fusion device by 50% to maintain the normal H-mode operation.

(1) This invention of the supersonic molecular beam injecting device is able to make particles penetrate the edge transport barriers (ETB) to maintain the fueling efficient at about 40%;

(2) In Tokamak H-mode operation, this invention is able to make injected particles penetrate the last closed magnetic flux surface (LCFS) into the plasma edge pedestal region; in the condition of power threshold below 10%, it has the capability of making the L-H transition(L-H);

(3) The Tokamak high confinement mode can cause I-type edge localized mode (ELM) instability, and the heat load of the components facing the plasma has the possibility of exceeding the maximum allowable value of 10 MW/m², which threats the normal operation of fusion device; in the operation of H-mode, the injected particles of this invention is able to penetrate ETB fueling, increase the ELM frequency and decrease the ELM amplitude, which gives the mitigation of the edge localized mode instability and reduces the heat load on wall surface by 50% to maintain the normal H-mode operation.

### BRIEF DESCRIPTION OF THE DRAWINGS

FIG. 1 shows the structure of this invention of the supersonic molecular beam injecting device;

FIG. 2 shows the formation of the supersonic molecular beam;

FIG. 3 shows the data of mitigation of the edge localized mode (ELM) instability with the supersonic molecular beam injection;

In the figures the numbers stand for: 1-the first high pressure seal joint; 2-cold/heat channel joint; 3-ceramic Kovar sealing power and signals plug; 4-molecular beam injection line positioning cylinder; 5-magnetic shielding cylinder; 6-adiabatic sleeve; 7-cold/heat precipitator; 8-lengthened Laval nozzle; 9-molecular beam valve; 10-second high pressure seal joint; 11-thermal buffer Pipeline; 12-flange.

### DEDAILED DESCRIPTION OF THE PREFERED EMBODIMENTS

As shown in FIG. 1, the invention of the supersonic molecular beam injecting device comprises: a molecular beam valve 9, a cold/heat precipitator 7 and a magnetic shielding cylinder 5. There is a lengthened Laval nozzle 8 in the outlet of the molecular beam valve 9; the molecular beam valve 9 is located in the cold/heat precipitator 7, and the cold/heat precipitator 7 is located in the magnetic shielding cylinder 5; the molecular beam valve 9 is also fixed on a flange 12 which is connected to the vacuum chamber of a fusion device.

The inlet of the molecular beam valve 9 is connected to high pressure gas by the high pressure seal joint 10 and a solenoid gas pipeline through the flange 12 to the high pressure seal joint 1; the outlet of the molecular beam valve 9 locates a lengthened Laval nozzle 8, and the size of the aperture of the molecular beam valve 9 is the same as the size of the aperture of the lengthened Laval nozzle 8 with the apertures on the same axis. In this embodiment, the size of the aperture of the molecular beam valve 9 has specifications of 0.1 mm to 0.5 mm. The depth (length) of the lengthened Laval nozzle 8 has specifications of 58 mm to 68 mm, with a conical inner wall of which the half-angle of the cone has specifications of 6° to 25°.

The cold/heat precipitator 7 is connected to a cold/heat provider system by a cold/heat channel joint 2, with a temperature tuning range 100˜500K by changing the temperature of the gas to change the velocity of the supersonic molecular beam. In this embodiment, there is a adiabatic sleeve 6 located between the cold/heat precipitator 7 and the magnetic shielding cylinder 5, for adiabatically keeping temperature for the cold/heat precipitator 7; the gas temperature is measured by a thermodetector made with platinum resistance, which is attached to the cold/heat precipitator 7, to and by means of the gas temperature estimating the velocity of the supersonic molecular beam with the molecular beam velocity scaling law; the cold provider system can be a liquid nitrogen infusion system, and the heat provider system can be a pressure steam infusion system.

The magnetic shielding cylinder 5 is made of conventional soft iron material for shielding the ambient stray magnetic field of the fusion device to ensure the normal operation of the molecular beam valve 9. In this embodiment, the magnetic shielding cylinder 5 in which locates the molecular beam valve 9 and cold/heat precipitator 7, is connected to a flange 12 by a molecular beam injection line positioning cylinder 4, and the flange 12 is connected to the vacuum chamber of a fusion device.

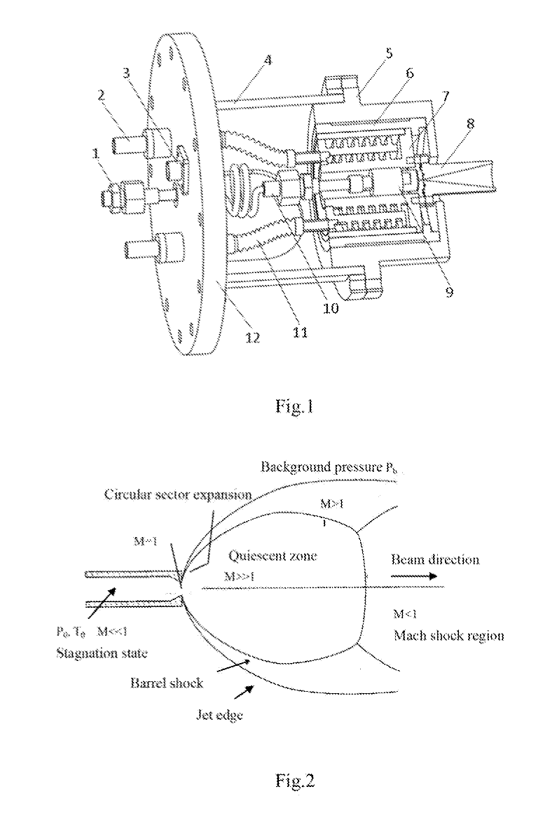

The forming principle of the supersonic molecular beam of the invention is shown as FIG. 2: in the stagnation state the high pressure gas flows to vacuum by lengthened Laval nozzle 8, with the acceleration of pressure difference (Pₒ−P_{b}) and with circular sector expansion into the vacuum region (quiescent region) in which mach number M>>1, existing supersonic molecular beam. Pₒ is the pressure of the high pressure gas in the stagnation state, and P_{b} is the background vacuum pressure.

The working procedures of the supersonic molecular beam injecting device of the present invention are as follows:

when starting the device, making the pressure for the molecular beam valve 9 and the solenoid gas pipelines evacuated to less than 10⁻⁴ Pa through the high pressure seal joint 1;

switching on high pressure gas source to provide high pressure gas with the purity higher than 99.999% and 0.2˜8.0 MPa pressure range to the molecular beam valve 9 through the high pressure seal joint 1;

the cold/heat precipitator 7 increases/decreases the temperature of the gas in the molecular beam valve 9 to the needed temperature;

starting the driver of the molecular beam valve 9 to emit molecular beam serial pulses to the high-temperature plasma of the fusion device with the pre-set pulse numbers, the pulse width and pulse interval time.

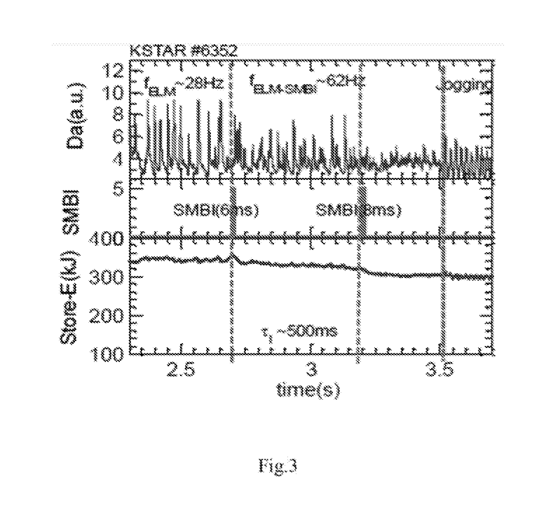

FIG. 3 shows the results of the use of the supersonic molecular beam injection in the large-scale superconducting Tokamak KSTAR. It shows the result data of mitigation of the edge localized mode instability with the supersonic molecular beam injection: with multiple pulses of deuterium supersonic molecular beam injection, the ELM frequency is 28 Hz before the mitigation and 62 Hz after the mitigation, which increases the frequency by 1.2 times; and the ELM amplitude decreases greatly. The longest mitigation time of the single pulse can last 500 ms.

1. A supersonic molecular beam injecting device comprising a molecular beam valve, a cold/heat precipitator and a magnetic shielding cylinder, said molecular beam valve located in said cold/heat precipitator and said magnetic shielding cylinder in sequence from inside to outside, said molecular beam valve fixed on a flange which is connected to the vacuum chamber of a fusion device, the outlet of said molecular beam valve having a lengthened Laval nozzle, the injecting velocity of the supersonic molecular beam tuned by changing the temperature of said cold/heat precipitator.

2. The device of claim 1, wherein the inlet of said molecular beam valve is connected to high pressure gas by the high pressure seal joint; the outlet of said molecular beam valve has a lengthened Laval nozzle, and the size of the aperture of said molecular beam valve is the same as the size of the aperture of said lengthened Laval nozzle with the apertures on the same axis.

3. The device of claim 2, wherein the size of the aperture of said molecular beam has specifications of 0.1 mm to 0.5 mm and the length of said lengthened Laval nozzle is over 58 mm with a conical inner wall of which the half-angle of the cone has specifications of 6° to 25°.

4. The device of claim 1, wherein said cold/heat precipitator is connected to a cold/heat provider system by a cold/heat channel joint.

5. The device of claim 2, wherein said cold/heat precipitator is connected to a cold/heat provider system by a cold/heat channel joint.

6. The device of claim 4, wherein said cold provider system is a liquid nitrogen infusion system, and said heat provider system is a pressure steam infusion system.

7. The device of claim 5, wherein said cold provider system is a liquid nitrogen infusion system, and said heat provider system is a pressure steam infusion system.

8. The device of claim 1, wherein said cold/heat precipitator has a temperature tuning range 100˜500K.

9. The device of claim 2, wherein said cold/heat precipitator has a temperature tuning range 100˜500K.

10. The device of claim 1, wherein there is an adiabatic sleeve between said cold/heat precipitator and said magnetic shielding cylinder.

11. The device of claim 2, wherein there is an adiabatic sleeve located between said cold/heat precipitator and said magnetic shielding cylinder.

12. The device of claim 1, wherein said cold/heat precipitator has temperature measuring device.

13. The device of claim 2, wherein said cold/heat precipitator has temperature measuring device.

14. The device of claim 1, wherein said magnetic shielding cylinder is made of soft iron material.

15. The device of claim 2, wherein said magnetic shielding cylinder is made of soft iron material.

16. The device of claim 1, wherein said magnetic shielding cylinder is connected by a molecular beam injection line positioning cylinder to a flange which is connected to the vacuum chamber of a fusion device.

17. The device of claim 2, wherein said magnetic shielding cylinder is connected by a molecular beam injection line positioning cylinder to a flange which is connected to the vacuum chamber of a fusion device.

18. The working procedures of the supersonic molecular beam injecting device of claim 1 are as follows:
when starting the device, making the pressure for the molecular beam valve and the solenoid gas pipelines evacuated to less than 10⁻⁴ Pa;
switching on high pressure gas source to provide high pressure gas with the purity higher than 99.999% and 0.2˜8.0 MPa pressure range to the molecular beam valve;
the cold/heat precipitator increases/decreases the temperature of the gas in the molecular beam valve to the needed temperature;
starting the driver of the molecular beam valve to emit molecular beam serial pulses to the high-temperature plasma of the fusion device with the pre-set pulse numbers, the pre-set pulse width and the pre-set pulse interval time.
